(19) United States
(12) Patent Application Publication
(10) Pub. No.: US 2015/0052817 A1
(43) Pub. Date: Feb. 26, 2015

(54) Window Lock With Corner Drive And Lock Points Along A Side And The Top Of The Window

(71) Applicant: ROTO FRANK OF AMERICA, INC., Chester, CT (US)

(72) Inventors: Brian Bourgoin, East Haddam, CT (US); Chris Griffin, Groton, CT (US)

(73) Assignee: ROTO FRANK OF AMERICA, INC., Chester, CT (US)

(21) Appl. No.: 13/975,795

(22) Filed: Aug. 26, 2013

(51) Int. Cl. E05C 1/08; E05D 15/04; E06B 3/34

(52) U.S. Cl. CPC E05C 1/08; E06B 3/34; E05D 15/04
USPC 49/394; 292/96

(57) ABSTRACT

A locking system for a casement window that provides a corner drive assembly for transmitting vertical movement of a lock bar along one side of the window frame into horizontal movement of a lock bar disposed along a top of the window frame. Thus, lock points on both the non-hinged side of the window frame as well as the top of the window frame may be provided. The corner drive assembly includes a side plunger that is coupled to the side lock bar and a top plunger that is coupled to a top lock bar. Both side and top keepers are provided to provide lock points along the non-hinged side as well as the top of the window. The system may also be extended with a second corner drive assembly in the second upper corner of the casement window and that may extend down the hinged side of the frame and sash as well.

### BACKGROUND

1. Technical Field

This disclosure relates to a lock system for a casement or swinging window. The disclosed lock system may include a corner drive mechanism and at least two lock points, one disposed along a vertical side of the window and another disposed along the top of the window.

2. Description of the Related Art

Casement windows typically include a sash with a pane of glass that is pivotally connected to a window frame by one or more hinges that connect one side of the sash to one side of the window frame. To lock a casement window, the sash is pivoted to a closed position against the window frame and a lock system is actuated. The lock system may include one or more lock bars that are slidably mounted to the window frame. For example, the lock bar may be slidably mounted to the side of the window frame opposite the side of the window frame that is connected to the hinge(s).

At least one boss may be mounted on the lock bar for engaging a keeper mounted to the sash. The lock bar may be coupled to a lock handle or actuator for sliding the lock bar between an open position and a locked position. In the open position, the boss is not in engagement with the keeper and the window may be pivoted open. In the locked position, the lock bar and boss have been slid until the boss has engaged a ramped portion of the keeper that results in a biasing or pulling of the sash against the window frame.

The lock bar may have a plurality of bosses mounted on the lock bar. Each boss may engage a ramped keeper disposed along an edge of the window sash. If a plurality of bosses and keepers are employed, the bosses and keepers are usually spaced apart so the bosses engage the keepers in a sequential manner, starting from the bottom of the sash and ending with the top of the sash. As a result, the bottom of the sash is normally locked first and the sequential interaction of the middle and top bosses with the middle and top keepers respectively results in the middle and top portions of the sash being pulled against the frame as the sash is locked shut. The engagement of a boss of a lock bar with a keeper of a sash is hereinafter referred to as a lock point.

Lock bars are typically offered in only a few lengths, while casement window sizes can vary greatly. Thus, manufacturers of lock systems for casement windows offer far fewer lock bar lengths than the number of casement window sizes that are available. Further, because the lock handle or actuator is disposed at a predetermined distance from the lower corner of the window, lock bars are also installed at a uniform distance from the lower corner of a casement window. Because lock bars are available in only a few lengths, the gap between the top lock point (i.e., the boss disposed at the upper end of the lock bar and the keeper disposed closest to the upper corner of the sash) and the upper corner of the window may vary substantially. This variable gap between the top lock point and the upper corner of the window may result in varying window performance. For purposes of this disclosure, the term window performance will refer to at least two aspects of a window: (1) the extent to which the casement window is airtight when the sash is locked against the frame; and (2) the structural soundness of the locked casement window.

Window performance as defined above is a function of the ability of the lock bar to secure the window sash tightly against the window frame. In addition, testing has shown that window performance improves when the top lock point is positioned closer to the upper corner of the window. However, placing the top lock point close to the upper corner of the window would require the length of the lock bar to be matched against the height of the window, which would require manufacturers of casement window lock systems to dramatically increase the number of available lock bar lengths.

Currently, casement windows in North America include a single lock bar on the non-hinge side of the window. Hinges and snubbers secure the hinge side of the sash to the frame. Typically, there is no means to lock the top of a casement window. In extreme load conditions, the sash can bow outward away from the frame, thereby both increasing air infiltration and compromising the structural soundness of the window. Because energy efficiency is an important consideration, the lack of a lock point along the top of a casement window is a significant shortcoming, especially with larger casement windows.

Therefore, an improved lock mechanism for casement windows of varying sizes is needed. A casement window lock mechanism that includes a lock point along the top of the window is also needed. Further, a casement window lock system that includes a lock point on the hinge/snubber side of the window is also needed.

### SUMMARY OF THE DISCLOSURE

A locking system for casement windows disclosed. The locking system may include a first side plunger that is slidably coupled to a lock for moving the first side plunger along a first axis between open and closed positions. The first side plunger may be coupled to a first boss for engaging a first side keeper. The first side plunger may be coupled to at least one first corner transfer band. The first corner transfer band may be flexible and slidably extend around a first corner block before coupling the first side plunger to a first top plunger. The first top plunger may be slidable along a second axis that is at least substantially perpendicular to the first axis.

In another aspect, a casement window is disclosed. The casement window may include a frame that receives a sash. The frame may include a top disposed between a hinge side and a lock side of the frame. The sash may also include a top disposed between a hinge side and a lock side of the sash. The window may further include a first side plunger that is slidably mounted to the lock side of the frame. The first side plunger may also be coupled to a lock for moving a first side plunger along a first axis between open and locked positions. The first side plunger may be coupled to a first boss for engaging a first side keeper. The first side plunger may also be coupled to a first corner transfer band. The first side keeper may be mounted to the lock side of the window sash. The first corner transfer band may be flexible and may slidably extend around a first corner block before coupling the first side plunger to a first top plunger. The first top plunger may be slidable along a second axis that is at least substantially perpendicular to the first axis. The first top plunger may be coupled to one or more top bosses for engaging one or more top keepers when the lock is moved to the locked position. And, the top keeper(s) may be mounted to the top of the window sash.

In any one or more of the embodiments described above, the at least one transfer band may be a plurality of transfer bands or a laminate of a plurality of flexible bands.

In any one or more of the embodiments described above, the locking system or window my further include first side lock bar that couples the lock to the first side plunger. The first side lock bar may be slidable along an axis that is at least substantially parallel to the first axis.

In any one or more of the embodiments described above, the first side lock bar may be used to couple the lock to a first connecting link. The first connecting link may couple the first side lock bar to the first side plunger. The first side lock bar and first connecting link may be slidable along axes that are at least substantially parallel to the first axis.

In any one or more of the embodiments described above, the connecting link may include a length-adjustable bar having a proximal end coupled to the first side lock bar and a distal end. The distal end of the bar may be received in a socket disposed at a proximal end of the first side plunger. In such an embodiment, a length of the bar extending from the proximal to the distal end of the bar may be easily shortened by cutting or breaking the bar along a serration, perforation or weak point disposed along the bar.

In any one or more of the embodiments described above, the first side plunger may include a first side boss for engaging a first side keeper when the lock is moved to the locked position.

In any one or more of the embodiments described above, the first top plunger may be coupled to a first top boss for engaging a first top keeper when the lock is moved to the locked position.

In any one or more of the embodiments described above, the first top plunger may be coupled to a first top boss for engaging a first top keeper when the lock is moved to the locked position. Further, the first side keeper and first top keeper may be disposed at least substantially perpendicular to one another.

In any one or more of the embodiments described above, the first top plunger may be coupled to a first top lock bar. The first top lock bar may be slidable along an axis that is at least substantially parallel to the second axis. The first top lock bar may include a first top boss for engaging a first top keeper when the lock is moved to the locked position. In such an embodiment, the first side keeper and the first top keeper may be disposed at least substantially perpendicular to one another.

In any one or more of the embodiments described above, the casement window or locking system may include a second top plunger coupled to the first top plunger. The second top plunger may be slidable along an axis that is at least substantially parallel to the second axis. The second top plunger may be coupled to a second corner transfer band. The second corner transfer band may be flexible and may extend slidably around a second corner block before coupling the second top plunger to a second side plunger. The second side plunger may be slidable along a third axis that is at least substantially parallel to the first axis but that extends along the hinged side of the window frame.

Other advantages and features will be apparent from the following detailed description when read in conjunction with the attached drawings.

### BRIEF DESCRIPTION OF THE DRAWINGS

For a more complete understanding of the disclosed methods and apparatuses, reference should not be made to the embodiment illustrated in greater detail on the accompanying drawings, wherein:

FIG. 1 is a perspective view of a casement window.

FIG. 2 is a partial rear perspective view of the casement window shown on FIG. 1 with the sash removed thereby exposing the lock bar disposed on the non-hinged side of the window frame as well as the operator extending through a bottom portion of window frame.

FIG. 3 is a partial rear perspective and schematic view of a disclosed casement window locking system.

FIG. 4 is a plan view of another disclosed casement window locking system.

FIG. 5 is a partial exploded view of a disclosed casement window locking system, particularly illustrating the corner drive assembly and the connecting link.

FIG. 6 is an exploded view of a corner drive assembly shown on FIG. 5.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

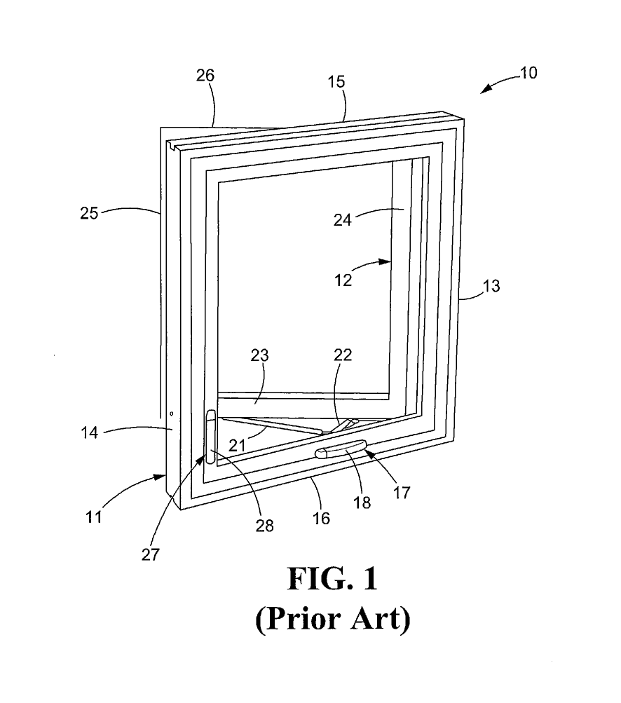

FIG. 1 illustrates a window 10 including a frame 11 that is pivotally connected to a sash 12 that is shown in a partially open position. The frame 11 includes a hinged side 13, a non-hinged side 14, a top 15 and a bottom 16. The bottom 16 of the frame 11 typically includes an opening (not shown) through which a window operator 17 is mounted. The operator 17 includes a handle 18 that is rotatably coupled to a pair of arms 21, 22 that are pivotally connected to a bottom 23 of the sash 12. The sash 12 also includes a hinged side 24, a non-hinged side 25, and a top 26. The non-hinged side 14 of the frame 11 also includes an opening (not shown) for accommodating a lock 27 that includes a handle 28. Because FIG. 1 does not illustrate the details of the locking system associated with the lock 27, FIG. 1. is also a depiction of the prior art casement window.

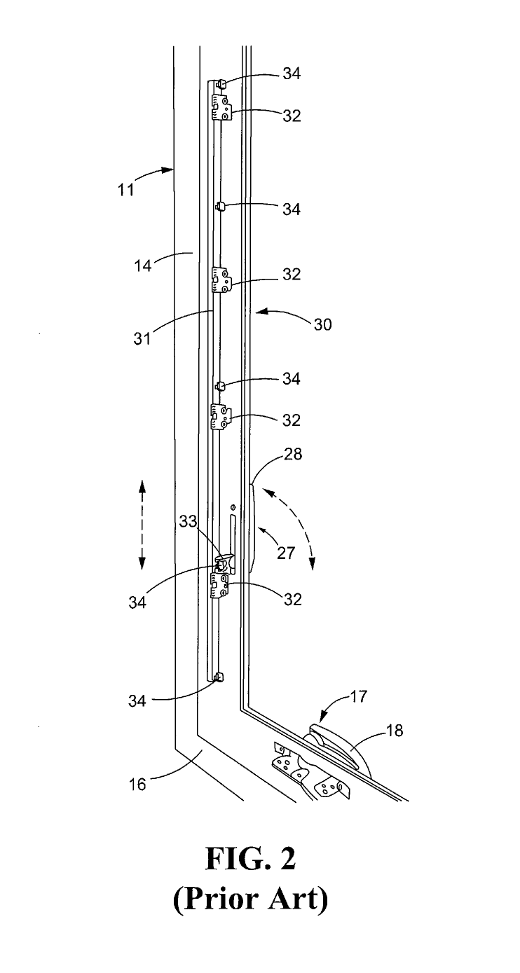

FIG. 2 illustrates a locking system 30 that includes a lock the lock 27, of which only the handle 28 is seen in FIG. 2. The handle 28 is coupled to a lock bar 31. The lock bar 31 is slidably coupled to the non-hinged side 14 of the window frame 11. The slidable connection of the lock bar 31 to the non-hinged side 14 is provided through use of a plurality of guides 32. The lock bar 31 slidably passes through the guides 32 upon actuation of the handle 28. Specifically, the handle 28 is coupled to the lock bar 31 by the fork 33 that receives one of the bosses 34 that may be coupled to the lock bar 31 as shown on FIG. 2. In addition to coupling the lock bar 31 to the fork 33 and therefore the handle 28, the bosses 34 also engage keepers (not shown) mounted to the non-hinged side 25 of the window sash 12. The locking system 30 shown in FIG. 2 is exemplary of a prior art locking system. Bosses 34 for engaging keepers (not shown) mounted to the non-hinged side 25 of the window sash 12 are spaced apart along the lock bar 31 so that the keepers disposed on the non-hinged side 25 of the window sash 12 are engaged sequentially beginning with the keeper disposed closest to the bottom 23 of the sash 12 and ending with the keeper disposed closest to the top 26 of the sash 12.

Typically, lock bars like that shown in 31 in FIG. 2 are offered in a few lengths with fewer lock bar length variations than casement window sizes. Because the position of the lock 27 and lock handle 28 are relatively fixed with respect to the bottom 16 of the frame 11, the distance between the upper boss 34 of the lock bar 31 (see the top of FIG. 2) varies with respect to the top 15 (not shown in FIG. 2, see FIG. 1) of the frame 11. Thus, a gap between the top 15 of the frame 11 and the upper lock point or boss 34/keeper combination will vary. Increases in the distance between the upper boss 34/keeper point and the top 15 of the window frame 11 affects window performance because a large gap between the upper boss 34/keeper and the top 15 of the frame 11 adversely affects the ability of locking system 30 to seal the sash 12 shut against the frame 11.

In addition to a substantial gap between the upper boss 34/keeper, on a large casement window 10, the prior art locking system 30 shown in FIG. 2 provides no means for locking the top 26 of the sash 12 to the top 15 of the frame 11. In extreme load conditions, the sash 12 can bow outward, drastically increasing air infiltration and adversely affecting the energy efficiency as well as the structural performance of the window 10. As noted above, energy efficiency is an increasingly important consideration when consumers are purchasing casement windows and locking systems for casement windows.

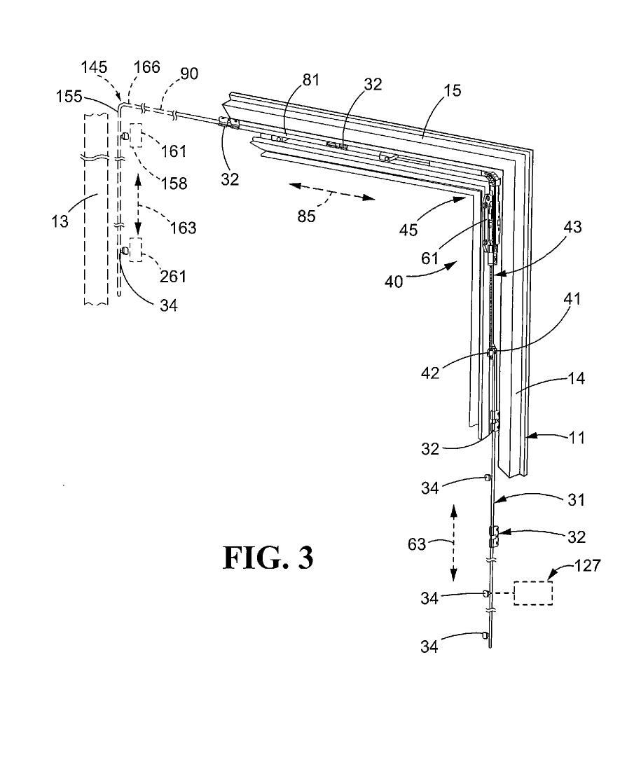

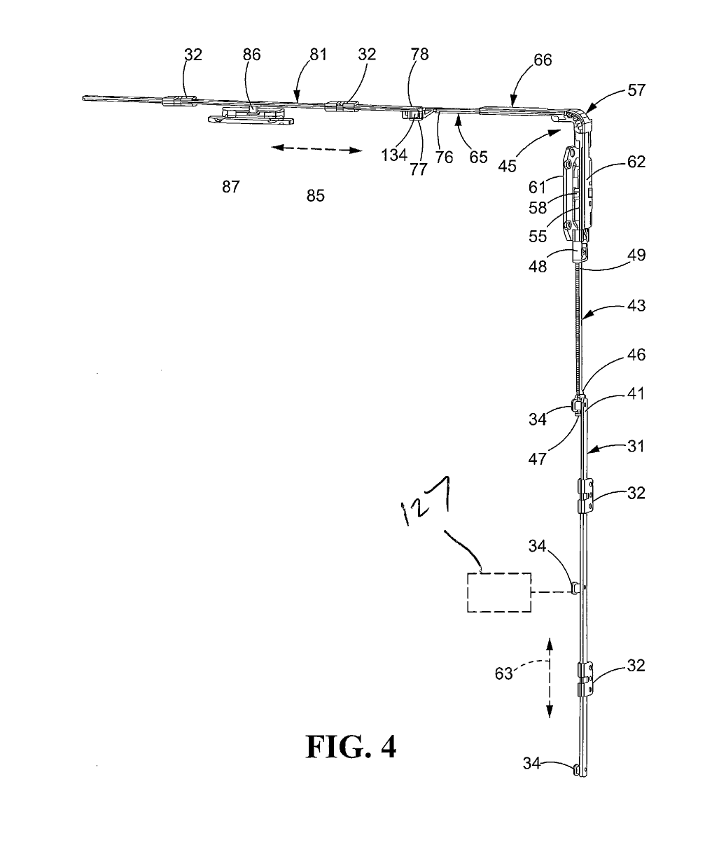

The above noted problems are overcome by the locking system 40 illustrated in FIG. 3. The locking system 40 may be installed on the non-hinged side 14 as well as the top 15 of the window frame 11 and, as also shown schematically in FIG. 3, the system 40 may be extended to the hinged side 13 of the frame. The locking system 40 may be coupled to a conventional lock bar 31. The conventional lock bar 31 may be coupled to a lock or actuator 127 as shown schematically in FIG. 3. The actuator 127 may be coupled to a boss 34 or may be fixedly coupled to the lock bar 31 that may be slidably coupled to the non-hinged side 14 of the window frame 11 with the guides shown at 32. A distal end 41 of the lock bar 31 may include a boss 42 that may be coupled to a connecting link 43 as shown in FIG. 3 and in greater detail in FIG. 4. The connecting link 43 may be used to couple the standard lock bar 31 to the corner drive assembly 45.

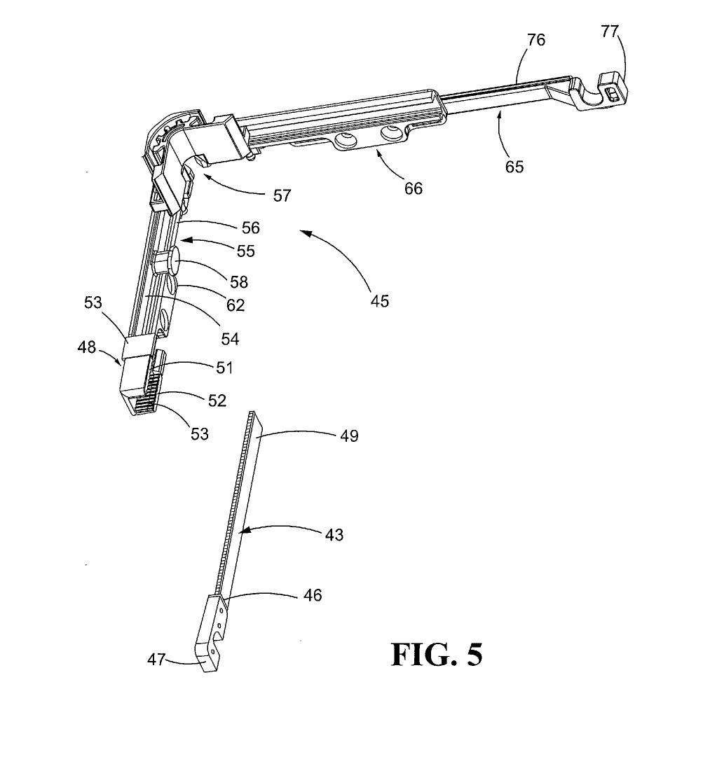

Referring to FIG. 4, the connecting link 43 includes a proximal end 46 that may include a hook 47 for receiving the boss 34 disposed at the distal end 41 of the lock bar 31. The connecting link 43 may also include a distal end 49 that may include a socket 48. The socket 48 may include interior walls 51, 52 that may include frictional surfaces, one of which is shown at 53 in FIG. 5. The frictional surfaces 53 lockingly engage the serrations 54 disposed on the edges of the connecting link 43 as best seen in FIG. 5. Because the connecting link 43 is serrated, the overall length of the connecting link 43 between the proximal end 46 and the distal end 49 may be adjusted by simply breaking off the distal end 49 of the connecting link 43 to shorten connecting link 43 to the desire length. Of course, perforations, creases, scores or other weak points may be placed along the connecting link 43 for the purpose of adjusting the length of the connecting link 43.

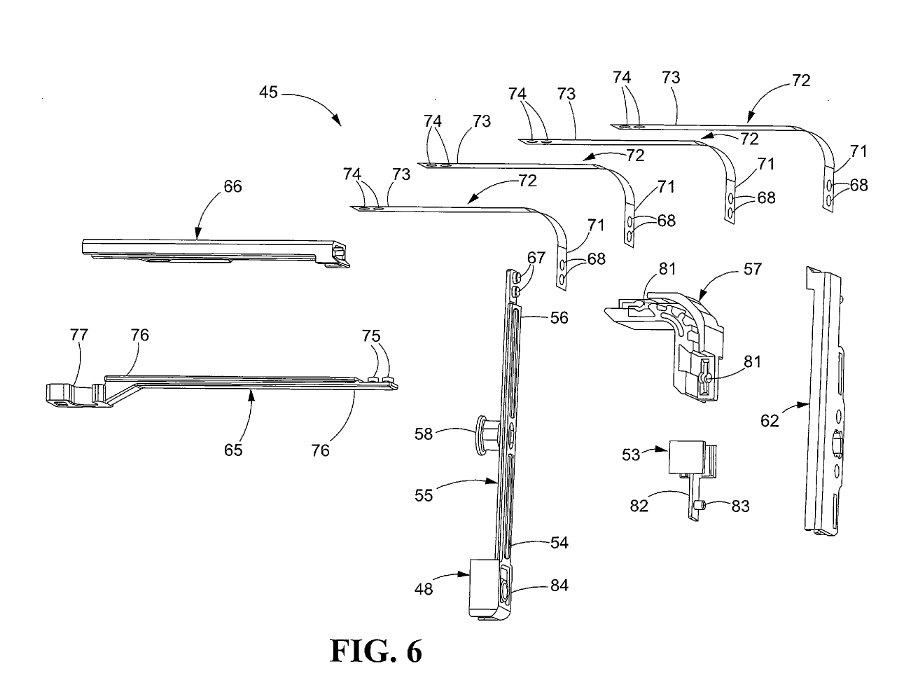

Referring to FIGS. 3-5, the socket 48 may be coupled to a securing clip 53 disposed at the proximal end 54 of the first side plunger 55. The first side plunger 55 may also include a distal end 56 that extends into the corner block 57 as explained in greater detailed in connection with FIG. 6. Returning to FIG. 5, the first side plunger 55 may also include a first side boss 58 as shown in FIGS. 4 and 5, which may engage a first side keeper 61 as shown in FIG. 4. Thus, the first side boss 58 and first side keeper 61 form a first lock point near the corner of the window.

FIGS. 4 and 5 also illustrate the first side frame 62 which slidably accommodates the first side plunger 55 and secures the first side plunger 55 to the non-hinged side 14 of the window frame 11 (FIGS. 1 and 3). Thus, axial vertical movement in either direction as indicated by the double ended arrow 63 that is imparted to the lock bar 31 by the actuator 127 results in vertical axial movement of the connecting link 43 and first side plunger 55. That vertical movement is translated to the first top plunger 65 as best seen on FIG. 5. The first top plunger 55 is slidably accommodated in a first top frame 66 that may be fixably secured to the top 15 of the window frame 11. The coupling between the first side plunger 55 and the first top plunger 65 is illustrated in FIG. 6.

Referring to the first side plunger 55 in FIG. 6, the reader will note that the distal end 56 of the first side plunger 55 may include one or more cleats 67. The cleats 67 are received in openings 68 disposed at the proximal ends of one or more transfer bands 72. The transfer band(s) 72 may be fabricated from a stiff but flexible material, such as a spring steel. The transfer bands 72 may also include distal ends 73 that may include openings 74. The openings 74 may receive the cleats 75 disposed at the proximal end 76 of the first top plunger 65. The first top plunger 65 may be slidably received in the first top frame 66, which may be secured to the top 15 of the window frame 11. The first top plunger 65 may also include a distal end 76 equipped with a hook 77 for engaging a boss 134 disposed at a proximal end 78 of a top lock bar 81 as shown in FIG. 4. The top lock bar 81 may be slidably coupled to the top 15 of the window frame 11 using guides 32 as shown in FIGS. 3-4.

The corner block 57 is best illustrated in FIG. 6. Essentially, the corner block 57 is secured to the intersection of the top 15 and non-hinged side 14 of the window frame 11 using fasteners (not shown) through the openings 81. The corner block 57 provides a curved pathway for slidably receiving the transfer bands 72. While the transfer bands 72 are flexible, they are also sufficiently stiff. Therefore, upward movement of the first side plunger 55 is translated into horizontal movement of the distal ends 73 of the transfer bands 72 thereby transmitting horizontal movement to the first top plunger 65 through the first top frame 66. Also shown in FIG. 6 is the attachment clip 53, which includes a leg 82 and a cleat 83 that may be received in the opening 84 in the socket 48 of the first side plunger 55.

Thus, vertical movement in either direction along the line 63 as shown in FIG. 4 results in horizontal movement in either direction along the line 85 shown in FIG. 4. The use of one or more transfer bands 72 through the corner block 57 enables this effective conversion of vertical movement along the line 63 into horizontal movement along the line 85 (FIG. 4).

The top lock bar 81 and a top boss 86 may be used to engage a top striker 87, which secures the top 26 of the window sash 12 to the top 15 of the frame 12 (FIGS. 1 and 4). As shown on FIG. 4, the corner drive assembly 45 may be coupled to a top lock bar 81. As shown in FIG. 3, the top lock bar 81 may be coupled to an additional sliding element 90 that may be a connecting link or another lock bar which, in turn, may be coupled to another corner drive assembly 145 which may provide a lock point disposed towards the upper end of the hinged side 13 of the window frame by providing a second side boss 158 and second side keeper 161. The second side boss 158 may be coupled to a second side plunger 155 indicated schematically in FIG. 3 at 155 along with a second top plunger 166. A second connecting link (not shown) may be used to connect the second side plunger 155 to a second side lock bar 131 which may provide additional bosses 34 for engaging additional side keepers 261 as illustrated schematically in FIG. 3.

### INDUSTRIAL APPLICABILITY

The disclosed corner drive assembly allows vertical travel of a side lock bar to be transmitted through a corner block using one or more flexible transfer bands, that may be made from stainless steel or another suitable alloy. Thus, the corner drive assembly converts vertical movement of a side lock bar into horizontal movement of a top lock bar for locking a top of a casement window. The corner drive assembly also provides for a side lock point disclosed close to a top corner of the window. The corner block is preferably made from a low friction polymer. Further, the corner drive assembly is modular and may be used on an already installed window with a single side lock bar. The adjustable connecting link may be used to provide a custom modification to an existing window installation. Further, as shown in FIG. 3, an additional corner drive may be installed in the other upper corner of the window to provide an additional lock points on the hinged side of the window and sash as well as on the top of the window. The installation as illustrated in FIGS. 3 and 4 provides improved window performance because it provides a better airtight seal between the sash and the frame as well as improved structural soundness of the locked casement window as the sash is more securely locked within the frame. Thus, kits for modifying existing casement windows are disclosed as well as complete locking systems for new casement windows or for replacement of prior art locking systems on existing casement windows.

While only certain embodiments have been set forth, alternatives and modifications will be apparent from the above description to those skilled in the art. These and other alternatives are considered equivalents and within the spirit and scope of this disclosure and the appended claims.

What is claimed:

1. A locking system for a casement window, the locking system comprising:
a first side plunger slidably coupled to a lock for moving the first side plunger along a first axis between open and locked positions, the first side plunger being coupled to a first boss for engaging a first side keeper;
the first side plunger coupled to a first corner transfer band;
the first corner transfer band being flexible and slidably extending around a first corner block before coupling the first side plunger to a first top plunger;
the first top plunger being slidable along a second axis that is at least substantially perpendicular to the first axis.

2. The locking system of claim 1 further including a first side lock bar that couples the lock to the first side plunger, the first side lock bar being slidable along an axis that is at least substantially parallel to the first axis.

3. The locking system of claim 1 further including a first side lock bar that couples the lock to a first connecting link, the first connecting link coupling the first side lock bar to the first side plunger, the first side lock bar and first connecting link being slidable along axes that are at least substantially parallel to the first axis.

4. The locking system of claim 3 wherein the connecting link includes a serrated bar having a proximal end coupled to the first side lock bar and a distal end, the distal end of the serrated bar being received in a socket disposed at a proximal end of the first side plunger;
wherein a length of the serrated bar extending from the proximal to the distal end thereof may be shortened.

5. The locking system of claim 1 wherein the first side plunger includes a first side boss for engaging a first side keeper when the lock is moved to the locked position.

6. The locking system of claim 1 wherein the first top plunger is coupled to a first top boss for engaging a first top keeper when the lock is moved to the locked position.

7. The locking system of claim 5 wherein the first top plunger is coupled to a first top boss for engaging a first top keeper when the lock is moved to the locked position; and
wherein the first side keeper and first top keeper are disposed at least substantially perpendicular to one another.

8. The locking system of claim 1 wherein the first top plunger is coupled to a first top lock bar,
the first top lock bar being slidable along an axis that is at least substantially parallel to the second axis, the first top lock bar including a first top boss for engaging a first top keeper when the lock is moved to the locked position.

9. The locking system of claim 5 wherein the first top plunger is coupled to a first top lock bar,
the first top lock bar being slidable along an axis that is at least substantially parallel to the second axis, the first top lock bar including a first top boss for engaging a first top keeper when the lock is moved to the locked position; and
wherein the first side keeper and first top keeper are disposed at least substantially perpendicular to one another.

10. The locking system of claim 1 further including a second top plunger coupled to the first top plunger, the second top plunger being slidable along an axis that is at least substantially parallel to the second axis;
the second top plunger being coupled to a second corner transfer band;
the second corner transfer band being flexible and slidably extending around a second corner block before coupling the second top plunger to a second side plunger;
the second side plunger being slidable along a third axis that is at least substantially parallel to the first axis.

11. The locking system of claim 10 further including a first side lock bar that couples the lock to the first side plunger, the first side lock bar being slidable along an axis that is at least substantially parallel to the first axis.

12. The locking system of claim 10 further including a first side lock bar that couples the lock to a first connecting link, the first connecting link coupling the first side lock bar to the first side plunger, the first side lock bar and first connecting link being slidable along axes that are at least substantially parallel to the first axis.

13. The locking system of claim 10 wherein the first side plunger includes a first side boss for engaging a first side keeper when the lock is moved to the locked position.

14. The locking system of claim 10 wherein the first top plunger is coupled to a first top boss for engaging a first top keeper when the lock is moved to the locked position.

15. The locking system of claim 13 wherein the first top plunger is coupled to a first top boss for engaging a first top keeper when the lock is moved to the locked position; and
wherein the first side keeper and first top keeper are disposed at least substantially perpendicular to one another.

16. The locking system of claim 10 wherein the first top plunger is coupled to a first top lock bar,
the first top lock bar being slidable along an axis that is at least substantially parallel to the second axis, the first top lock bar including a first top boss for engaging a first top keeper when the lock is moved to the locked position.

17. The locking system of claim 13 wherein the first top plunger is coupled to a first top lock bar;
the first top lock bar being slidable along an axis that is at least substantially parallel to the second axis, the first top lock bar including a first top boss for engaging a first top keeper when the lock is moved to the locked position; and
wherein the first side keeper and first top keeper are disposed at least substantially perpendicular to one another.

18. The locking system of claim 13 wherein the second side plunger includes a second side boss for engaging a second side keeper when the lock is moved to the locked position.

19. A casement window comprising:
a frame that receives a sash, the frame including a top disposed between a hinge side and a lock side of the frame;
the sash also including a top disposed between a hinge side and a lock side of the sash;
a first side plunger slidably mounted to the lock side of the frame, the first side plunger also coupled to a lock for moving the first side plunger along a first axis between open and locked positions, the first side plunger being coupled to a first boss for engaging a first side keeper, the first side plunger also coupled to a first corner transfer band;
the first side keeper being mounted to the lock side of the sash;
the first corner transfer band being flexible and slidably extending around a first corner block before coupling the first side plunger to a first top plunger;
the first top plunger being slidable along a second axis that is at least substantially perpendicular to the first axis, the first top plunger being coupled to a first top boss for engaging a first top keeper when the lock is moved to the locked position; and
the first top keeper being mounted to the top of the sash.

20. The casement window of claim 19 further including a first side lock bar that couples the lock to a first connecting link, the first connecting link coupling the first side lock bar to the first side plunger, the first side lock bar and first connecting link being slidable along axes that are at least substantially parallel to the first axis.
